(19) United States
(12) Patent Application Publication
(10) Pub. No.: US 2026/0303811 A1
(43) Pub. Date: Oct. 1, 2026

(54) METHOD OF ENCODING/DECODING FOR PERFORMING MACHINE VISION TASK AND COMPUTER READABLE RECORDING MEDIUM STORING INSTRUCTIONS FOR IMPLEMENTING ENCODING METHOD

(71) Applicants: Electronics and Telecommunications Research Institute, Daejeon (KR); UNIVERSITY INDUSTRY FOUNDATION, YONSEI UNIVERSITY MIRAE CAMPUS, Wonju-si (KR)

(72) Inventors: Sang Woon KWAK, Daejeon (KR); Soon Heung JUNG, Daejeon (KR); A Young KIM, Daejeon (KR); Kwang Deok SEO, Wonju-si (KR); Eunbin AN, Wonju-si (KR); Min Suk KIM, Wonju-si (KR)

(73) Assignees: Electronics and Telecommunications Research Institute, Daejeon (KR); UNIVERSITY INDUSTRY FOUNDATION, YONSEI UNIVERSITY MIRAE CAMPUS, Wonju-si (KR)

(21) Appl. No.: 19/632,594

(22) Filed: Mar. 30, 2026

(30) Foreign Application Priority Data
Mar. 28, 2025 (KR) 10-2025-0040656
Mar. 27, 2026 (KR) 10-2026-0055866

(51) Int. Cl. H04N 19/132; H04N 19/136; H04N 19/172; H04N 19/46

(52) U.S. Cl. CPC H04N 19/132; H04N 19/136; H04N 19/172; H04N 19/46

(57) ABSTRACT

According to a method of encoding an image to perform a machine vision task in the present disclosure, the method comprising sampling pictures included in an intra-period; and encoding remaining pictures included in the intra-period, wherein in response to the number of remaining picture, after the sampling, is less than a threshold value, at least one fake picture is inserted into the intra-period.

### BACKGROUND OF THE INVENTION

### Field of the Invention

The present disclosure relates to an image encoding/decoding method and device for performing a machine vision task.

### Description of the Related Art

Conventionally, video encoding/decoding technology has improved video compression efficiency and image quality by considering the human visual system. However, future video encoding/decoding technology is expected to be widely used not only for human vision but also in machine vision fields such as surveillance, intelligent transportation, smart cities, and intelligent industry.

Accordingly, there is a need to develop video encoding/decoding technology by which high-efficiency compression and recognition accuracy can be obtained by simultaneously considering human vision and machine vision.

### SUMMARY OF THE INVENTION

It is an object of the present disclosure to provide a method of adaptively performing temporal resampling while satisfying random access condition.

It is a further object of the present disclosure to provide a method of encoding/decoding information regarding a fake picture.

The technical problems to be achieved by the present disclosure are not limited to the technical problems mentioned above, and other technical problems not mentioned herein may be clearly understood by those skilled in the art from the description below.

In accordance with an aspect of the present disclosure, the above and other objects can be accomplished by the provision of a method of encoding an image to perform a machine vision task, the method comprising sampling pictures included in an intra-period; and encoding remaining pictures included in the intra-period. Here, in response to the number of remaining picture, after the sampling, is less than a threshold value, at least one fake picture is inserted into the intra-period.

In the method of encoding an image to perform a machine vision task according to the present disclosure, a number of fake pictures inserted into the intra-period represents a difference between the threshold value and a number of remaining pictures included in the intra-period.

In the method of encoding an image to perform a machine vision task according to the present disclosure, the threshold value is per-defined in an encoding device.

In the method of encoding an image to perform a machine vision task according to the present disclosure, a flag indicating whether a corresponding picture is a fake picture or not is encoded for each of the remaining pictures excluding a first picture and a last picture of the intra-period.

In the method of encoding an image to perform a machine vision task according to the present disclosure, information indicating a number of fake pictures in the intra-period is encoded.

In the method of encoding an image to perform a machine vision task according to the present disclosure, a fake picture is inserted between pictures with the largest POC (Picture Order Count) difference among the remaining pictures in the intra-period.

In accordance with an aspect of the present disclosure, the above and other objects can be accomplished by the provision of a method of decoding an image to perform a machine vision task, the method comprising decoding pictures in an intra-period; and generating a restore picture at a location where decoding was omitted, Here, at least one of decoded picture in the intra-period is a fake picture.

In the method of decoding an image to perform a machine vision task according to the present disclosure, a flag indicating whether a decoded picture is a fake picture or not is decoded for each of decoded pictures excluding a first decoded picture and a last decoded picture in the intra-period.

In the method of decoding an image to perform a machine vision task according to the present disclosure, in response to a decoded picture having a first POC (Picture Order Count) being a fake picture, the decoded picture is discarded and a restored picture is generated for the first POC.

In the method of decoding an image to perform a machine vision task according to the present disclosure, information specifying a number of fake pictures in the intra-period is decoded.

Meanwhile, in the present disclosure, it is possible to provide a computer-readable recording medium recording instructions for implementing the method of decoding an image to perform a machine vision task.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a block diagram of a video encoder according to an embodiment of the present disclosure.

FIG. 2 is a block diagram of a video decoder according to an embodiment of the present disclosure.

FIG. 3 is a diagram illustrating the structure of GoS and SGoS.

FIG. 4 is a diagram illustrating an example of an object tracking-based adaptive resampling technique.

FIG. 5 is a diagram illustrating an example of an object tracking-based dynamic resampling technique.

FIG. 6 illustrates an example where a section in which random access is not supported is present.

FIG. 7 is a diagram illustrating a method for inserting a fake picture according to an embodiment of the present disclosure.

FIG. 8 is a flowchart of a temporal resampling process and a temporal restoration process according to an embodiment of the present disclosure.

### DETAILED DESCRIPTION OF THE INVENTION

As the present disclosure may make various changes and have multiple embodiments, specific embodiments are illustrated in a drawing and are described in detail in a detailed description. But, it is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but they do not need to be mutually exclusive. For example, a specific shape, structure and characteristic described herein may be implemented in other embodiment without departing from a scope and a spirit of the present disclosure in connection with an embodiment. In addition, it should be understood that a position or an arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, a term such as first, second, etc. may be used to describe a variety of elements, but the elements should not be limited by the terms. The terms are used only to distinguish one element from other element. For example, without getting out of a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that it may be directly connected or linked to that another element, but there may be another element between them. Meanwhile, when an element is referred to as being “directly connected” or “directly linked” to another element, it should be understood that there is no another element between them.

As construction units shown in an embodiment of the present disclosure are independently shown to represent different characteristic functions, it does not mean that each construction unit is composed in a construction unit of separate hardware or one software. In other words, as each construction unit is included by being enumerated as each construction unit for convenience of a description, at least two construction units of each construction unit may be combined to form one construction unit or one construction unit may be divided into a plurality of construction units to perform a function, and an integrated embodiment and a separate embodiment of each construction unit are also included in a scope of a right of the present disclosure unless they are beyond the essence of the present disclosure.

A term used in the present disclosure is just used to describe a specific embodiment, and is not intended to limit the present disclosure. A singular expression, unless the context clearly indicates otherwise, includes a plural expression. In the present disclosure, it should be understood that a term such as “include” or “have”, etc. is just intended to designate the presence of a feature, a number, a step, an operation, an element, a part or a combination thereof described in the present specification, and it does not exclude in advance a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not a necessary element which performs an essential function in the present disclosure and may be an optional element for just improving performance. The present disclosure may be implemented by including only a construction unit which is necessary to implement essence of the present disclosure except for an element used just for performance improvement, and a structure including only a necessary element except for an optional element used just for performance improvement is also included in a scope of a right of the present disclosure.

Hereinafter, an embodiment of the present disclosure is described in detail by referring to a drawing. In describing an embodiment of the present specification, when it is determined that a detailed description on a relevant disclosed configuration or function may obscure a gist of the present specification, such a detailed description is omitted, and the same reference numeral is used for the same element in a drawing and an overlapping description on the same element is omitted.

The present disclosure proposes a pair of image encoder and image decoder for video encoding/decoding for machines. The pair of image encoder and image decoder described in the present disclosure may support machine consumption or hybrid machine-human consumption. Here, human consumption refers to normal human video watching, and machine consumption refers to machine tasks performed through video. Examples of machine tasks include object classification, object recognition, object detection, object segmentation, object tracking, super resolution, or frame interpolation.

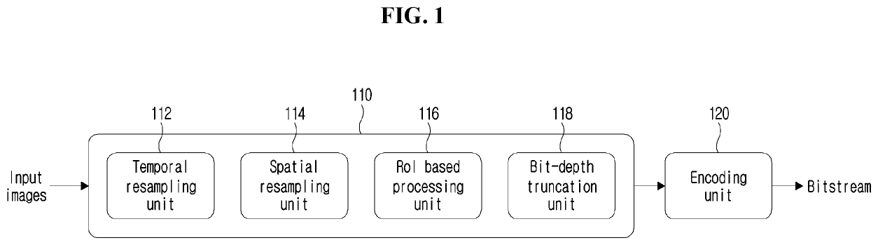

FIG. 1 is a block diagram of a video encoder according to an embodiment of the present disclosure.

Referring to FIG. 1, the video encoder may include a preprocessing unit 110 and an image encoding unit 120.

The preprocessing unit 110 performs a preprocessing process to convert input original images into images suitable for image encoding. Here, images input to the preprocessor 110 may be color or black-and-white images conforming to the YUV, RGB or YCbCr format.

The preprocessing unit 110 may include at least one of a temporal resampling unit 112, a spatial resampling unit 114, a Rol (region-of-interest)-based processing unit 116 or bit-depth truncation unit 118.

The temporal resampling unit 112 temporally resamples images. Only resampled images may be selected for image encoding. That is, encoding of some of the images input to the preprocessor 110 may be omitted through temporal resampling. For example, a 60 fps (frame per second) video may be converted into a 30 fps video by omitting odd-numbered images of the 60 fps video. Alternatively, images in a specific output order may be omitted by considering temporal redundancy between images.

The temporal resampling may be performed in units of sequences or sub-sequences.

The spatial resampling unit 114 spatially resamples an image. The size and/or spatial resolution of an image may be reduced through spatial resampling. For example, an image with a resolution of 1920×1080 may be converted to an image with a resolution of 960×540 or 480×270.

The spatial resampling may be performed in units of sequences or sub-sequences.

The Rol-based processing unit 116 sets a region of interest in an image such that image encoding/decoding is performed focusing on information important to machine inference tasks. The region-of-interest-based processing unit 116 may remove a background region excluding the set region of interest or adjust the size and/or location of the region of interest in the image, so that the region of interest is set to be encoded/decoded with high quality. Here, removing the background region may involve filling the background region with a specific value.

The bit-depth truncation unit 118 performs bit depth truncation on the input image. Specifically, by performing a right-shifting operation on the input image, the amount of bits to be encoded may be reduced.

Meanwhile, the bit depth truncation may be performed on at least one of the color components.

For example, if a YUV format image is input, a 1-bit right-shifting operation may be performed only on the Y component.

The image encoding unit 120 encodes the image output from the preprocessing unit 110. Meanwhile, the image encoding unit 120 may encode the image using conventional codec technology or a codec technology modified based on the conventional codec technology for VCM (Video Coding for Machine). As an example, the image encoding unit 120 may encode the image based on HEVC, VVC, or AV1. As a result of image encoding, a bitstream is generated and the generated bitstream may be transmitted to a video decoder.

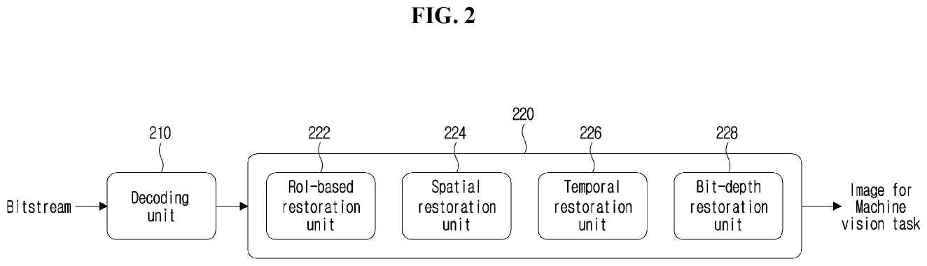

FIG. 2 is a block diagram of a video decoder according to an embodiment of the present disclosure.

Referring to FIG. 2, the video decoder may include an image decoding unit 210 and a post-processing unit 220.

The image decoding unit 210 decodes a bitstream received from the video encoding unit 110 to generate a decoded or reconstructed image. The image decoding unit 210 may decode the bitstream based on the codec technology used in the image encoding unit 120.

The post-processing unit 220 performs post-processing on the decoded image. Through post-processing, the size and frame rate of the images may be restored to match the original images.

The post-processing unit 220 may include at least one of a Rol-based reconstruction unit 222, a spatial reconstruction unit 224, a temporal reconstruction unit 226 or a bit-depth reconstruction unit 228.

The Rol-based reconstruction unit 222 obtains an image of the same size as an original image based on Rol information. For example, when a cropped image is encoded such that a region of interest is included therein, the decoded image has a different size from the original image. Accordingly, the Rol-based reconstruction unit 222 may adjust the retargeted image to the original size. Here, the retargeted image may represent a decoded image or an image on which upscaling has been performed through the spatial reconstruction unit 224. Alternatively, when the size or position of a region of interest in an encoding target image has been adjusted, the Rol-based reconstruction unit 222 may adjust the position and size of the region of interest in the retargeted image to match the original image.

The spatial reconstruction unit 224 performs upscaling on a decoded image. The decoded image may be reconstructed to be an image having the same size and/or spatial resolution as the original image through upscaling.

The temporal reconstruction unit 226 reconstructs an image at a temporal position where encoding/decoding has been omitted through temporal resampling. Specifically, the temporal reconstruction unit 226 may generate an image at a temporal position where encoding/decoding has been omitted through interpolation between decoded images.

The bit-depth reconstruction unit 228 restores the bit-depth of the input image to its original bit-depth. Specifically, by performing a left-shifting operation on the input image, the bit-depth of the input image may be restored to the original bit-depth.

Meanwhile, bit restoration may be performed on at least one of the color components.

For example, if a YUV format image is input, a 1-bit left-shifting operation may be performed only on the Y component.

Meanwhile, in order to perform reverse processing on the image processing performed in the preprocessor 110, additional information may be encoded and signaled. The post-processor 220 may perform post-processing on decoded images based on the additional information to generate images for machine inference. The additional information may be referred to as “metadata”.

Metadata may include at least one of temporal resampling information, spatial resampling information, or region-of-interest processing information.

The temporal resampling information may include at least one of a flag indicating whether temporal resampling has been performed or information indicating a temporal resampling rate.

For example, the flag indicates that temporal resampling has been performed when set to 1. In this case, information indicating a temporal resampling rate may be additionally encoded/decoded. When temporal resampling is performed, fewer images than the number of original images may be encoded/decoded. The video decoder can reconstruct images for which encoding/decoding has been omitted through temporal reconstruction.

On the other hand, the flag indicates that temporal resampling has not been performed when set to 0.

The temporal resampling rate may be represented as an exponent of 2. For example, a temporal resampling rate of 2\hat{ }N indicates that one of 2\hat{ }N images is selected as an encoding/decoding target image. For example, only images having a picture order count (POC) of a multiple of 2\hat{ }N can be encoded/decoded. Information representing the temporal resampling rate may represent the exponent (i.e., N) of the temporal resampling rate. As an example, the information may represent the exponent value of the temporal resampling rate or the value obtained by subtracting 1 from the exponent value.

The spatial resampling information may include at least one of a flag indicating whether spatial resampling has been performed or information indicating a scaling parameter for spatial resampling.

As an example, the flag indicates that spatial resampling has been performed when set to 1. In this case, information representing a scaling parameter may be additionally encoded. Specifically, information representing a horizontal scaling parameter and information representing a vertical scaling parameter may be encoded, respectively, and the encoded information may be signaled. When spatial resampling is performed, the size and/or spatial resolution of an image may be reduced. The video decoder may restore the size of a decoded image to the size of the original image or a pre-defined size, through spatial reconstruction. Meanwhile, information, indicating the pre-defined size, may be further encoded/decoded.

The flag indicates that spatial resampling has not been performed when set to 0.

The region-of-interest processing information may include at least one of image size information or region-of-interest information.

The image size information may include information indicating whether retargeting has been performed. If the retargeting flag is 1, it indicates that the retargeted image is encoded/decoded instead of the original image. On the other hand, if the retargeting flag is 0, it indicates that the original image is encoded/decoded as is.

The retargeted image indicates an image generated by performing at least one of resolution adjustment and position adjustment on at least one region of interest in the original image. Accordingly, the resolution or position of the region of interest in the retargeted image may be different from that of the original image. In addition, the size of the retargeted image may be the same as or smaller than that of the original image.

When retargeting is allowed (i.e., if the retargeting flag is 1), the size information of the retargeted image may be encoded/decoded. The size information of the retargeted image may include width information of the image and height information of the image.

Meanwhile, information indicating the size difference between the original image and the retargeted image may be additionally encoded/decoded. For example, information indicating whether a size difference between the size of the retargeted image and the size of the original image is encoded/decoded or not may be encoded/decoded.

For example, when the information, indicating whether the size difference is encoded/decoded or not, is 0, it indicates that the size difference between the retargeted image and the original image is not encoded/decoded.

On the other hand, when the information, indicating whether the size difference is encoded/decoded or not, is 1, it indicates that the size difference between the retargeted image and the original image is encoded/decoded. In this case, information indicating the size difference between the size of the retargeted image and the size of the original image may be additionally encoded/decoded.

The information representing the size difference indicates the size difference between the original image and the retargeted image. Information representing the size difference in the horizontal direction and information representing a size difference in the vertical direction may be encoded and signaled, respectively.

The region-of-interest information may include at least one of a flag indicating whether a region of interest is present, information on the number of regions of interest, a scaling parameter of a region of interest, or position information of a region of interest.

For example, when the flag is 1, it indicates that information on a region of interest may be encoded/decoded. In this case, at least one of the number of regions of interest, scaling parameter information of a region of interest, position information of a region of interest, or size information of a region of interest may be additionally encoded/decoded.

On the other hand, when the flag is 0, it indicates that a region of interest is not present.

The information on the number of regions of interest indicates the number of regions of interest. Meanwhile, the number of regions of interest may be calculated in units of image groups including at least one image.

A scaling parameter of a region of interest represents the scaling parameter with respect to the region of interest. Depending on the scaling parameter of the region of interest, the size of the region of interest may be adjusted.

Scaling parameter information of a region of interest may include information indicating whether the scaling parameter of the region of interest is updated. If the information, indicating whether the region of interest is updated or not, indicates that the scaling parameter of the region of interest will not be updated, the scaling parameter of the region of interest may be set to a default value or the same value as in the previous frame. On the other hand, when the information, indicating whether the region of interest is updated or not, indicates that the scaling parameter of the region of interest needs to be updated, the information indicating the scaling parameter of the region of interest may be additionally encoded/decoded.

Meanwhile, scaling parameter information of a region of interest may be encoded/decoded individually for each region of interest.

Position information of a region of interest indicates the position of the region of interest in the original image. The horizontal position (i.e., x-axis coordinate) information and vertical position (i.e., y-axis coordinate) information of the region of interest may be encoded/decoded.

Size information of a region of interest indicates the size of the region of interest in the original image. The horizontal size (i.e., width) information and the vertical size (i.e., height) information of the region of interest may be encoded/decoded.

The present disclosure provides a method for adaptively selecting pictures to which encoding/decoding is omitted when performing temporal resampling. This allows for increased compression efficiency without lowering machine vision task performance.

In addition, the present disclosure provides an improved bitstream structure and image structure for encoding/decoding information of a sampled picture to restore a picture from which encoding/decoding has been omitted.

The temporal resampling unit 112 may form a GoS (Group of Similar Pictures) or SGOS (Set of GoS) based on object tracking information. The temporal resampling unit 112 may perform temporal resampling on the GoS or SGOS to remove remaining pictures excluding the pictures to be encoded/decoded.

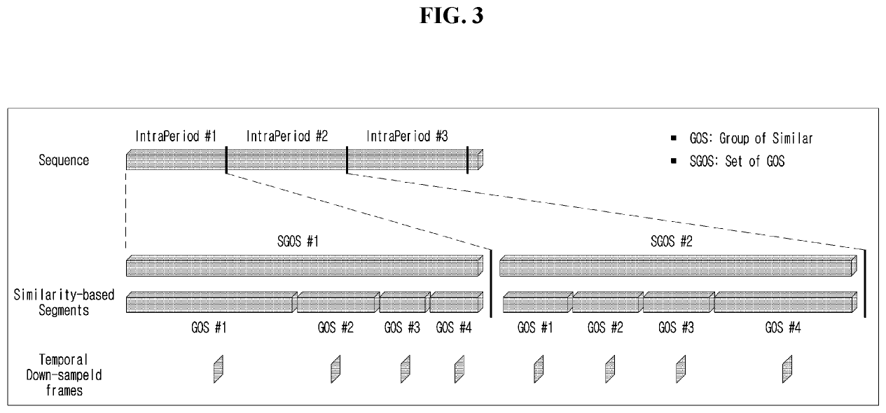

FIG. 3 is a diagram illustrating the structure of GoS and SGoS.

The input video may be composed of one or more SGoS. At this time, an SGOS may be constructed by considering the minimum decoding length. For example, in FIG. 3, the SGoS is illustrated as being constructed in intra-period unit.

An SGoS may be composed of one or more GoSs. Specifically, in the example illustrated in FIG. 3, each SGoS is illustrated as being composed of four GoSs.

Information regarding an SGoS may include the number of GoSs included in the SGoS and a list of GoSs included in the SGoS.

When similarity evaluation is performed sequentially on the pictures, the consecutive pictures may be grouped into a single GoS until a picture with a similarity to a reference picture below a threshold is found.

Through temporal resampling, a GoS may be resampled into a single picture. That is, since a GoS is a set of pictures with high similarity, only one of the pictures included in the GoS may be selected as the encoding/decoding target. Information regarding the GoS may include the position of the first picture constituting the GoS and the number of pictures whose encoding/decoding is omitted through temporal resampling.

Temporal resampling information for restoring the resampled video to its original length in the decoder may be encoded and signaled. Tables 1 to 3 show syntax structures containing temporal resampling information.

TABLE 1

| srd_temporal_restoration_data( ) { | Descriptor |
|---|---|
| cvd_num_units_in_tick | u(32) |
| cvd_time_scale | u(32) |
| srd_sgos_length | u(2) |
| srd_adaptive_temporal_resampling_flag | u(1) |
| srd_gos_cound | u(3) |
| byte_alignment( ) | |
| } | |

TABLE 2

| prd_temporal_restoration_data( ) { | Descriptor |
|---|---|
| prd_drop_pic_count | u(3) |
| } | |

TABLE 3

| prd_temporal_resampling_post_hint_parameters( ) { | Descriptor |
|---|---|
| trph_current_frame_quality_valid_flag | u(1) |
| trph_current_frame_quality_value | u(7) |
| } | |

Table 1 shows the syntax that is encoded/decoded at the sequence level. The structure srd_temporal_restoration_data( ) at the sequence level may include at least one of the syntax rsd_sgos_length, which indicates the length of the SGoS; the flag srd_adaptive_temporal_resampling_flag, which indicates whether adaptive temporal resampling is applied; or the syntax srd_gos_count, which indicates the number of GoS contained in the SGoS.

Table 2 shows the syntax that is encoded/decoded at the picture level. The structure prd_temporal_restoration_data( ) at the picture level may include the syntax prd_drop_pic_count, which indicates the number of pictures within the GoS that encoding/decoding have been omitted. Through the above syntax, the location of the first picture of the GoS may be derived.

Object tracking information may be collected to group pictures with high similarity.

Specifically, object tracking information may be collected for each picture, and the collected object tracking information may be compared with the reference object tracking information (or key object tracking information) of the reference picture. The first picture is set as the first picture of the first GoS, while the object tracking information of the first picture of the GoS may be set as the reference object information until the reference object information is updated.

After calculating the degree of overlap between the objects tracked in the target picture and the objects tracked in the reference picture, an evaluation may be made regarding whether the target picture is similar to the reference picture based on the calculation result. The calculation result may be derived as an AP (Average Precision) value.

If the calculation result is below a threshold, the target picture may be determined not to be similar to the reference picture. In this case, the pictures preceding the target picture may be set as a single GoS, and the target picture may be used as the first picture of the new GoS. Additionally, the target picture may be set as the reference picture, and the object tracking information of the target picture may be set as the reference tracking information.

On the other hand, if the calculation result is greater than the threshold, the target picture is inserted in the same GoS as the reference picture, and the number of pictures to which encoding/decoding is omitted for the current GoS may be increased by 1.

Once the GoS configuration is complete, the GoS may be inserted into the SGoS. Additionally, the GoS list constituting the SGoS may be updated to reflect the new GoS. Meanwhile, the SGoS may be configured considering the decoding-capable unit.

The completed GoS increases the number of GoS in the current SGOS by one and is included in the GoS list of the corresponding SGoS.

To sample temporally similar images, at least one of an object tracking-based adaptive resampling technique or an object tracking-based dynamic resampling technique may be used.

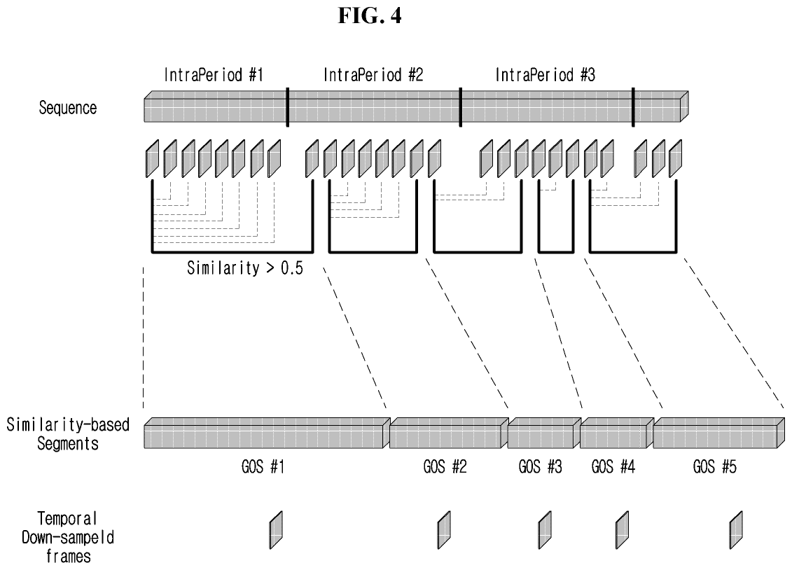

FIG. 4 is a diagram illustrating an example of an object tracking-based adaptive resampling technique.

The object tracking-based adaptive resampling technique is a method of forming consecutive pictures into a single GoS until a picture with a similarity to a reference picture below a threshold is found.

In the example illustrated in FIG. 4, the threshold is exemplified as 0.5, but the threshold may be set to a different value.

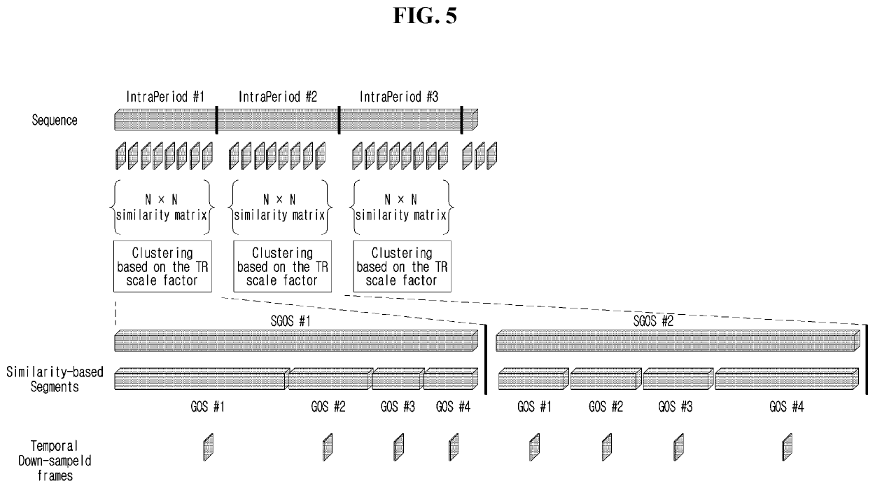

FIG. 5 is a diagram illustrating an example of an object tracking-based dynamic resampling technique.

The object tracking-based dynamic resampling technique is a method of applying temporal resampling by considering the minimum decoding unit. For example, the minimum decoding unit may represent an intra-period. That is, as shown in the example illustrated in FIG. 5, a GoS or SGOS cannot exist across multiple intra-periods.

When the object tracking-based dynamic resampling technique is applied, the first picture of the minimum decoding unit may be set as the reference picture. Additionally, when the object tracking-based dynamic resampling technique is applied, the number of pictures to be resampled within the minimum decoding unit (i.e., the number of pictures for which encoding/decoding is omitted) may be predefined. Furthermore, the positions of the pictures remaining within the minimum decoding unit (i.e., pictures subject to encoding/decoding) may be dynamically set. At this time, similar pictures may be classified using a K-nearest clustering technique based on object tracking information, and the locations of the remaining pictures may be determined by referring to the classification results of the similar pictures.

Meanwhile, clustering techniques other than K-nearest clustering may also be used.

A structure such as GoS or SGOS may be encoded through spatial resampling, ROI-based processing, bit depth truncation, and an internal codec (e.g., VVC to which MI-RPR is applied). Through the above encoding processing, a bitstream may be output finally.

Meanwhile, when an object tracking-based adaptive resampling technique is applied, the intra-period before temporal resampling and the intra-period after temporal resampling differ, which may result in cases where random access is impossible.

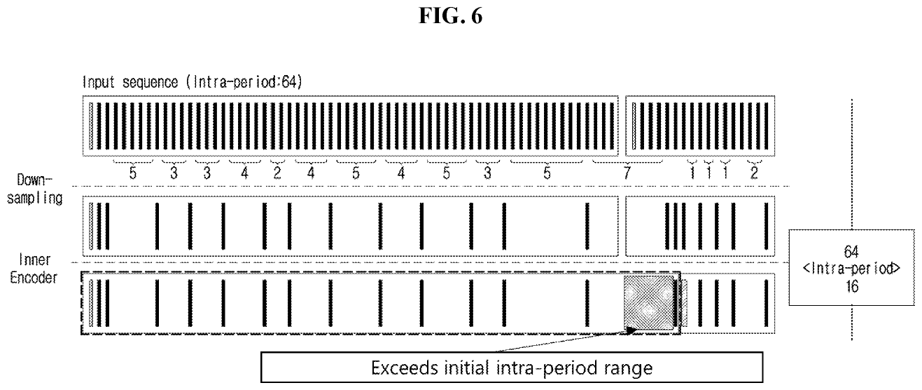

FIG. 6 illustrates an example where a section in which random access is not supported is present.

After selecting the pictures to be encoded/decoded through temporal resampling, encoding/decoding may be performed by setting a predefined number of consecutive pictures as a single GoP. For example, in FIG. 6, it is illustrated that 16 pictures are set as a single GoP (i.e., a single intra-period) after performing temporal resampling.

In this case, when a predefined number of pictures are set as an intra-period, there may occur a case where the range of the intra-period differs from the range of the intra-period prior to the temporal resampling.

For example, in the example illustrated in FIG. 6, a picture that was included in the second intra-period of the initial video sequence belongs to the first intra-period after temporal resampling is performed. In this case, there may occur a problem where random access is impossible for a section that fall outside the initial first intra-period. To resolve the above problem, the present disclosure proposes a method for inserting a fake picture such that the range of the intra-period set after performing temporal resampling does not exceed the range of the initial intra-period.

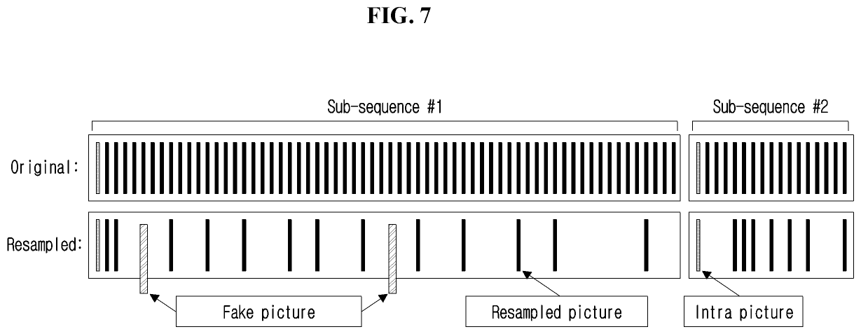

FIG. 7 is a diagram illustrating a method for inserting a fake picture according to an embodiment of the present disclosure.

For convenience of explanation, it is assumed that the initial length of an intra period is 64, and the modified length after performing temporal resampling is 16.

When temporal resampling is performed on pictures belonging to a specific intra period, if the number of remaining pictures to be encoded/decoded in the specific intra period is smaller than the modified length of the intra period, at least one fake picture may be inserted into the specific intra period.

As an example, in the example illustrated in FIG. 7, it is illustrated that through temporal resampling, only 14 of the 64 pictures belonging to the first intra period are selected as pictures to be encoded/decoded. Since the number of remaining pictures after temporal resampling is smaller than the modified length of the intra period, at least one fake picture may be inserted into the first intra period. At this time, the number of fake pictures to be inserted may be the difference between the modified length of the intra-period and the number of remaining pictures in the first intra-period. That is, as in the example illustrated in FIG. 7, two fake pictures may be inserted into the first intra-period.

Accordingly, the range of the intra-period can be maintained without changing even after temporal resampling.

Meanwhile, the length of the intra-period may be predefined in the encoder and decoder. Here, the length may include an initial length and a modified length.

Alternatively, information indicating the length of the intra-period may be encoded/decoded. For example, at least one of information indicating the initial length of the intra-period and information indicating the modified period of the intra-period may be encoded/decoded.

The location of the fake picture may be determined by considering the POC (Picture Order Count) difference between the pictures. For example, the fake picture may be inserted between the pictures with the largest POC difference.

Meanwhile, the insertion location of the fake picture may be determined such that the fake picture does not correspond to the first picture and/or the last picture of the intra-period.

The sub-sequence on which temporal resampling has been performed may be restored to the original length sub-sequence based on at least one of SGoS information or GoS information. At this time, the picture for which encoding/decoding has been omitted may be restored by interpolating the pictures.

Meanwhile, in the decoder, if the restored picture of a specific POC is a fake picture, the restored picture is discarded and a picture corresponding to the specific POC is regenerated. Specifically, the restored picture of a specific POC may be generated by interpolating two restored pictures adjacent to the specific POC.

To this end, information indicating whether the restored picture is a fake picture may be encoded/decoded.

For example, the above information may be a 1-bit flag. A flag of 1 indicates that the restored picture is a fake picture, and a flag of 0 indicates that the restored picture is not a fake picture.

Meanwhile, for the first picture and/or the last picture in the intra-period, the flag may not be encoded/decoded. That is, the flag may be encoded/decoded for each of the remaining pictures excluding the first picture and/or the last picture in the intra-period.

Meanwhile, a fake picture may be configured not to be used to generate a restored picture that has omitted encoding/decoding. For example, if at least one of two restored pictures adjacent to a POC that has omitted encoding/decoding is a fake picture, the restored picture with a POC difference greater than that of the fake picture with respect to the POC that has omitted encoding/decoding may be used.

Information indicating the number of fake pictures included in the intra-period may also be encoded/decoded.

Meanwhile, a fake picture may be restored by copying a picture that precedes it in the encoding/decoding order. In other words, after select one of the restored pictures prior to the fake picture, the selected picture may be set as the restored picture for the fake picture.

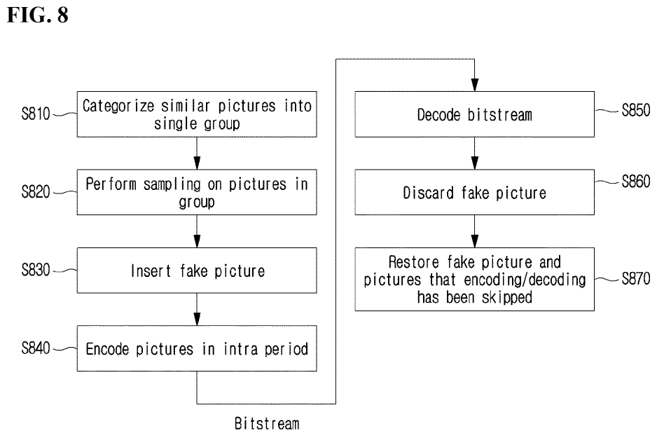

FIG. 8 is a flowchart of a temporal resampling process and a temporal restoration process according to an embodiment of the present disclosure.

Referring to FIG. 8, temporally similar pictures may be classified into a single group S810. Here, the group may represent a GoS.

The number of pictures to be encoded/decoded may be reduced by sampling the pictures belonging to the group S820. For example, only one picture within the GoS may be left and the remaining pictures removed, or the remaining pictures, excluding a predefined number of pictures, may be removed within the GoS.

If, through sampling, the number of remaining pictures in the intra-period is less than a threshold value, at least one fake picture may be inserted into the intra-period S830. Here, the threshold value represents the modified length of the intra-period.

At this time, the number of fake pictures inserted into the intra-period may correspond to the difference between the threshold value and the number of remaining pictures in the intra-period.

Pictures included in the intra-period may be encoded S840. Meanwhile, before encoding is performed, at least one of spatial resampling, ROI-based processing, or bit depth truncation may be applied to the encoding/decoding target picture. Additionally, encoding may be performed based on a VVC to which MI-RPR is applied.

In the decoder, restored pictures may be generated through decoding a bitstream S850.

A fake picture among the restored pictures are removed, and the fake picture and pictures for which encoding/decoding was omitted may be restored using the remaining restored pictures S860, S870.

Information for temporal resampling may be encoded and signaled so that the temporally resampled image can be restored in the decoder. The information may include at least one of GoS information or SGOS information.

According to the present disclosure, a method for adaptively performing temporal resampling while satisfying random access condition may be provided.

According to the present disclosure, a method for encoding/decoding information regarding a fake picture may be provided, thus, encoding/decoding efficiency can be enhanced.

The effects that may be obtained from the present disclosure are not limited to the effects mentioned above, and other effects not mentioned herein may be clearly understood by those skilled in the art from the above description.

A name of syntax elements introduced in the above-described embodiments is only temporarily given to describe embodiments according to the present disclosure. Syntax elements may be referred to as names different from those proposed in the present disclosure.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as an FPGA, a GPU, other electronic device, or a combination thereof. At least some of functions or processes described in illustrative embodiments of the present disclosure may be implemented by software and the software may be recorded in a recording medium. A component, a function, and a process described in illustrative embodiments may be implemented by a combination of hardware and software.

A method according to an embodiment of the present disclosure may be implemented by a program which may be performed by a computer and the computer program may be recorded in a variety of recording media such as a magnetic storage medium, an optical reading medium, a digital storage medium, etc.

A variety of technologies described in the present disclosure may be implemented by a digital electronic circuit, computer hardware, firmware, software, or a combination thereof. The technologies may be implemented by a computer program product, that is, a computer program tangibly implemented on an information medium or a computer program processed by a computer program (for example, a machine-readable storage device (for example, a computer-readable medium) or a data processing device) or a data processing device or implemented by a signal propagated to operate a data processing device (for example, a programmable processor, a computer, or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are located at one site or spread across multiple sites and are interconnected by a communication network.

An example of a processor suitable for executing a computer program includes a general-purpose and special-purpose microprocessor and one or more processors of a digital computer. In general, a processor receives an instruction and data in a read-only memory (ROM), a random-access memory (RAM), or both memories. A component of a computer may include at least one processor for executing an instruction and at least one memory device for storing an instruction and data. In addition, a computer may include one or more mass storage devices for storing data, for example, a magnetic disk, a magneto-optical disc, or an optical disc, or may be connected to the mass storage device to receive and/or transmit data. An example of an information medium suitable for implementing a computer program instruction and data includes a semiconductor memory device (for example, a magnetic medium such as a hard disk, a floppy disk, or a magnetic tape), an optical medium such as a compact disc read-only memory (CD-ROM), a digital video disc (DVD), etc., a magneto-optical medium such as a floptical disk, and a ROM, a RAM, a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, the processor device may include a plurality of processors or a processor and a controller. In addition, the processor device may configure a different processing structure like parallel processors. In addition, a computer readable medium means all media which may be accessed by a computer and may include both a computer storage medium and a transmission medium.

The present disclosure includes detailed description of various detailed implementation examples. However, it should be understood that the detailed content does not limit a scope of claims or an invention proposed in the present disclosure and describes features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in a form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from claims and a spirit and a scope of equivalents thereto.

Accordingly, the present disclosure includes all other replacements, modifications and changes belonging to the following claim.

What is claimed is:

1. A method of encoding an image for performing machine vision task, comprising:
sampling pictures included in an intra-period; and
encoding remaining pictures included in the intra-period,
wherein in response to the number of remaining picture, after the sampling, is less than a threshold value, at least one fake picture is inserted into the intra-period.

2. The method of claim 1, wherein a number of fake pictures inserted into the intra-period represents a difference between the threshold value and a number of remaining pictures included in the intra-period.

3. The method of claim 2, wherein the threshold value is per-defined in an encoding device.

4. The method of claim 1, wherein a flag indicating whether a corresponding picture is a fake picture or not is encoded for each of the remaining pictures excluding a first picture and a last picture of the intra-period.

5. The method of claim 2, wherein information indicating a number of fake pictures in the intra-period is encoded.

6. The method of claim 1, wherein a fake picture is inserted between pictures with the largest POC (Picture Order Count) difference among the remaining pictures in the intra-period.

7. A method of decoding an image for performing machine vision task, comprising:
decoding pictures in an intra-period; and
generating a restore picture at a location where decoding was omitted,
wherein at least one of decoded picture in the intra-period is a fake picture.

8. The method of claim 7, wherein a flag indicating whether a decoded picture is a fake picture or not is decoded for each of decoded pictures excluding a first decoded picture and a last decoded picture in the intra-period.

9. The method of claim 7, wherein in response to a decoded picture having a first POC (Picture Order Count) being a fake picture, the decoded picture is discarded and a restored picture is generated for the first POC.

10. The method of claim 7, wherein information specifying a number of fake pictures in the intra-period is decoded.

11. A non-transitory computer readable medium storing instructions when executed cause a computer to carry out:
sampling pictures included in an intra-period; and
encoding remaining pictures included in the intra-period,
wherein in response to the number of remaining picture, after the sampling, is less than a threshold value, at least one fake picture is inserted into the intra-period.
